(19) United States
(12) Patent Application Publication
(10) Pub. No.: US 2025/0132500 A1
(43) Pub. Date: Apr. 24, 2025

(54) ELECTRONIC DEVICE INCLUDING SPATIAL FILTER DEVICE

(71) Applicants: Samsung Electronics Co., Ltd., Suwon-si (KR); SEOUL NATIONAL UNIVERSITY R&DB FOUNDATION, Seoul (KR)

(72) Inventors: Jungi JEONG, Suwon-si (KR); Jungsuek OH, Suwon-si (KR); Jaehoon KIM, Suwon-si (KR); Seungwoo BANG, Suwon-si (KR)

(21) Appl. No.: 18/925,642

(22) Filed: Oct. 24, 2024

(30) Foreign Application Priority Data
Oct. 24, 2023 (KR) 10-2023-0143199

(51) Int. Cl. H01Q 9/44; H01Q 1/38

(52) U.S. Cl. CPC H01Q 9/44; H01Q 1/38

(57) ABSTRACT

The present disclosure relates to a 5G communication system or a 6G communication system for supporting higher data rates beyond a 4G communication system such as long term evolution (LTE). A spatial filter is provided. The spatial filter includes a first substrate having a first parasitic element configured to provide a filtering function and disposed on the spatial filter device, a second substrate having a second parasitic element configured to provide a filtering function and disposed under the spatial filter device, and a dipole antenna configured to transmit and receive radio waves in free space, coupled to each of the first parasitic element and the second parasitic element so as not to be aligned therewith, and disposed between the first substrate and the second substrate.

### CROSS-REFERENCE TO RELATED APPLICATION(S)

This application is based on and claims priority under 35 U.S.C. § 119(a) of a Korean patent application number 10-2023-0143199, filed on Oct. 24, 2023, in the Korean Intellectual Property Office, the disclosure of which is incorporated by reference herein in its entirety.

### JOINT RESEARCH AGREEMENT

The disclosure was made by or on behalf of the below listed parties to a joint research agreement. The joint research agreement was in effect on or before the date the disclosure was made and the disclosure was made as a result of activities undertaken within the scope of the joint research agreement. The parties to the joint research agreement are 1) Samsung Electronics Co., Ltd. and 2) SEOUL NATIONAL UNIVERSITY R&DB FOUNDATION.

### BACKGROUND

### 1. Field

The disclosure relates to a spatial filter structure having high-selectivity filter characteristics in wireless communication systems.

### 2. Description of Related Art

Considering the development of wireless communication from generation to generation, the technologies have been developed mainly for services targeting humans, such as voice calls, multimedia services, and data services. Following the commercialization of 5th generation (5G) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6th generation (6G) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in millimeter wave (mm Wave) bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

Spatial filter technology is being studied as one of the next-generation wireless communication signal filtering technologies. The spatial filter may replace the filter provided in a communication module and transmit only a specific frequency signal outside the antenna, thereby improving the signal-to-noise ratio of the communication signal.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method for designing a high-selectivity spatial filter incorporating a filtering antenna (filtenna) that has filtering components in the antenna itself.

Additional aspects will be set forth in part in the description which follows and, in part, will be apparent from the description, or may be learned by practice of the presented embodiments.

In accordance with an aspect of the disclosure, a spatial filter device is provided. The spatial filter device includes a first substrate having a first parasitic element configured to provide a filtering function and disposed on the spatial filter device, a second substrate having a second parasitic element configured to provide a filtering function and disposed under the spatial filter device, and a dipole antenna configured to transmit and receive radio waves in free space, coupled to each of the first parasitic element and the second parasitic element so as not to be aligned therewith, and disposed between the first substrate and the second substrate.

According to an embodiment, the first parasitic element is configured as a cross-shaped metal or a modified cross-shaped metal. According to an embodiment, the second parasitic element is configured as the cross-shaped metal or the modified cross-shaped metal.

According to an embodiment, the spatial filter device further includes a third substrate having a third parasitic element configured to provide a filtering function and disposed on the first substrate. The third parasitic element is coupled to the dipole antenna so as not to be aligned therewith.

In accordance with another aspect of the disclosure, an electronic device is provided. The electronic device includes a spatial filter device, and one or more processors communicatively coupled to the spatial filter device, wherein the spatial filter device includes a first substrate having a first parasitic element configured to provide a filtering function and disposed on the spatial filter device, a second substrate having a second parasitic element configured to provide a filtering function and disposed under the spatial filter device, and a dipole antenna configured to transmit and receive radio waves in free space, coupled to each of the first parasitic element and the second parasitic element so as not to be aligned therewith, and disposed between the first substrate and the second substrate.

The filter device according to the embodiment of the disclosure is able to operate outside the antenna, thereby providing improved filtering technology.

In addition, the filter device according to the embodiment of the disclosure is able to provide a filtenna-filtenna-based spatial filter, thereby providing a high-selectivity function.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1A and 1B are diagrams illustrating a method for improving signal interference through a filter according to various embodiments of the disclosure;

FIG. 2 illustrates an example of a unit cell and an equivalent circuit for a resonator-based spatial filter according to an embodiment of the disclosure;

FIG. 3 illustrates an example of a unit cell for an antenna-filter-antenna-based spatial filter according to an embodiment of the disclosure;

FIG. 4 illustrates a unit cell for a spatial filter implementing filtering performance according to an embodiment of the disclosure;

FIG. 5 illustrates an example of a dipole antenna and a non-aligned parasitic element according to an embodiment of the disclosure;

FIG. 6 is a diagram illustrating frequency cut-off characteristics in a case where parasitic elements are stacked in a spatial filter implementing filtering performance according to an embodiment of the disclosure;

FIG. 7 is a diagram illustrating a case in which the same effect as a cross-shaped parasitic element is obtained from a spatial filter implementing filtering performance according to an embodiment of the disclosure;

FIGS. 8A and 8B illustrate various cross-based parasitic elements according to various embodiments of the disclosure;

FIG. 9 is a diagram illustrating spatial filter transmission characteristics depending on the presence or absence of parasitic elements according to an embodiment of the disclosure;

FIG. 10 is a diagram illustrating cutoff frequency separation depending on parasitic element lengths according to an embodiment of the disclosure;

FIG. 11 is a diagram illustrating transmission characteristics depending on parasitic element alignment angles according to an embodiment of the disclosure;

FIG. 12 is a diagram illustrating transmission characteristics depending on each polarized wave according to an embodiment of the disclosure; and

FIG. 13 is a diagram illustrating an electronic device including an antenna module according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reason, in the accompanying drawings, some elements may be exaggerated, omitted, or schematically illustrated. Furthermore, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The various embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more central processing units (CPUs) within a device or a security multimedia card. Furthermore, the “unit” in embodiments may include one or more processors.

Each telecommunications company providing wireless communication service has respective allocated frequency bands adjacent to each other to operate a service, and interference signals due to reception of signals in bands other than the frequency allocated to the telecommunications company may cause a deterioration in the quality of the wireless communication service. In order to improve the quality deterioration due to the interference signal, there may be technical limitations as to the design and operation of a narrowband mechanical filter with high-selectivity characteristics in a high-frequency band of millimeter waves or higher.

Meanwhile, spatial filter technology is being studied as one of the next-generation wireless communication signal filtering technologies. A spatial filter may replace the filter provided inside a communication module and transmit only a specific frequency signal outside the antenna, thereby improving the signal-to-noise ratio of the communication signal. A spatial filter is configured as unit cells smaller than half a wavelength, which are arranged in a periodic lattice structure, and may form a surface structure in which a set thereof is larger than the wavelength.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

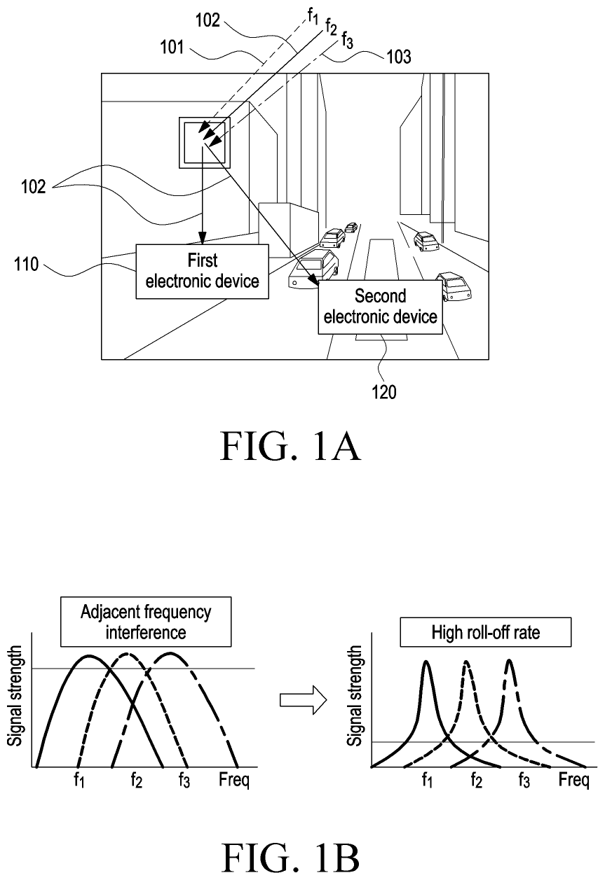

FIGS. 1A and 1B are diagrams illustrating a method for improving signal interference through a filter according to various embodiments of the disclosure.

Referring to FIG. 1A, a reflective reconfigurable intelligent surface (RIS) 100 incorporated with a spatial filter may receive a first signal 101 having a center frequency of f1, a second signal 102 having a center frequency of f2, and a third signal 103 having a center frequency of f3. The RIS may be implemented as a reflective reconfigurable intelligent surface that reflects a high-frequency band frequency to allow it to pass through an obstacle or transmit it to enter an indoor space.

The spatial filter included in the reflective RIS 100 may filter a signal (e.g., a second signal 102) to be transmitted to at least one of a first electronic device 110 and a second electronic device 120, among a plurality of signals transmitted to the reflective RIS 100.

At least one of the first electronic device 110 and the second electronic device 120 may receive a signal (e.g., the second signal 102) reflected and filtered by the reflective RIS 100.

Referring to FIGS. 1A and 1B, at least one of the first signal 101 having a center frequency of f1, the second signal 102 having a center frequency of f2, and the third signal 103 having a center frequency of f3, which are transmitted to the reflective RIS 100, may experience interference with adjacent frequencies.

In order to mitigate the interference with adjacent frequencies, a pre-configured roll-off rate may be configured by the spatial filter included in the reflective RIS 100. The above spatial filter may apply the roll-off rate to mitigate interference with adjacent frequencies for at least one of the first signal 101 having a center frequency of f1, the second signal 102 having a center frequency of f2, and the third signal 103 having a center frequency of f3.

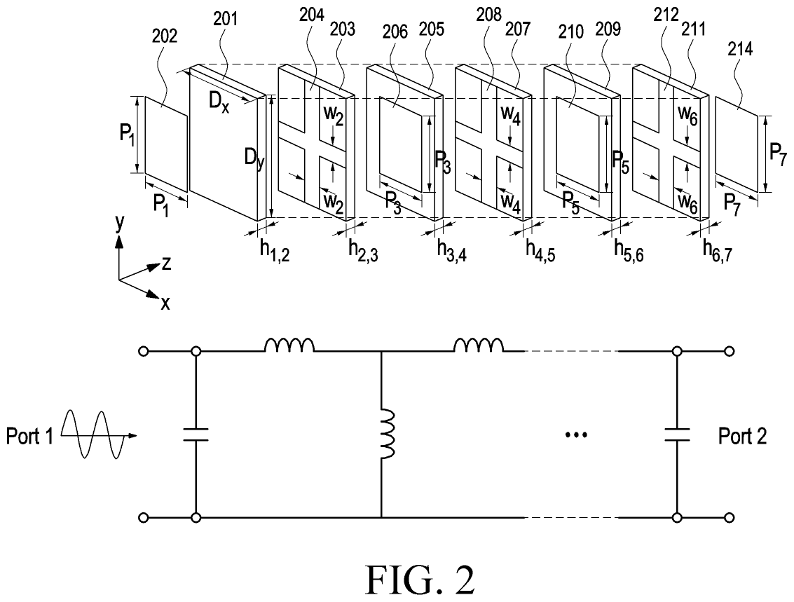

FIG. 2 illustrates an example of a unit cell and an equivalent circuit for a resonator-based spatial filter according to an embodiment of the disclosure.

Referring to FIG. 2, the resonator-based spatial filter 200 may be configured as a plurality of dielectric substrates 201, 203, 205, 207, 209, and 211, and metal structures 202, 204, 206, 208, 210, 212, and 214 disposed adjacent to the plurality of dielectric substrates 201, 203, 205, 207, 209, and 211.

A metal structure may be inserted into at least one of a first surface and a second surface of each of the plurality of dielectric substrates 201, 203, 205, 207, 209, and 211. An equivalent circuit for the dielectric substrates and the metal structures may be determined differently depending on the shapes of the metal structures. A resonator-based spatial filter may implement a filter response by a combination of parallel inductor-capacitor (LC) equivalent structures.

According to an embodiment, the metal structure may be configured in a rectangular or cross shape. According to an embodiment, if the metal structure is in a rectangular shape, it may be modeled as a parallel capacitor in the equivalent circuit, and if the metal structure is in a cross grid shape, it may be modeled as a parallel inductor in the equivalent circuit.

For example, a first dielectric substrate 201 may be configured to have a length of Dx in the x-axis direction, a length of Dy in the y-axis direction, and a height of h_{1,2} in the z-axis direction. For example, a first metal structure 202 may be configured in a rectangle having a length of PI in the x-axis direction and a length of PI in the y-axis direction.

For example, a second dielectric substrate 203 may be configured to have a length of Dx in the x-axis direction, a length of Dy in the y-axis direction, and a height of h_{2,3} in the z-axis direction. For example, a second metal structure 204 may be configured in a cross shape having a width of w₂ and disposed on the first surface of the second dielectric substrate 203.

For example, a third dielectric substrate 205 may be configured to have a length of Dx in the x-axis direction, a length of Dy in the y-axis direction, and a height of h_{3,4} in the z-axis direction. For example, a third metal structure 206 may be configured in a rectangle having a length of P3 in the x-axis direction and a length of P3 in the y-axis direction.

According to an embodiment, as the number of metal structures inserted between the dielectric substrates increases, the number of parallel LC elements of the equivalent circuit increases, which leads to an increase in the order of the filter response, thereby improving the high-selectivity characteristic of the spatial filter.

According to an embodiment, the spatial filter unit cell using square patches in two layers and the spatial filter unit cell using square patches in three layers may operate as a third-order low-pass filter and a fifth-order low-pass filter, respectively, and thus the slope in the cutoff band may be different.

According to an embodiment, the number of metal structures between the dielectric substrates may need to increase in order to implement a high-order function response of the resonator-based multilayer spatial filter. However, as the number of metal structures between the dielectric substrates increases, the size and manufacturing cost of the spatial filter for designing a spatial filter with high-selectivity characteristics may also increase.

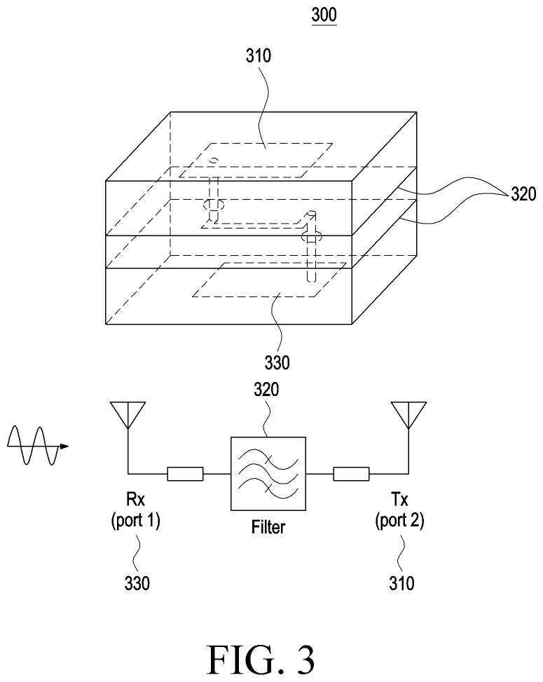

FIG. 3 illustrates an example of a unit cell for an antenna-filter-antenna-based spatial filter according to an embodiment of the disclosure.

Referring to FIG. 3, a unit cell structure 300 of the spatial filter may be configured as an antenna-filter-antenna-based structure. The unit cell structure 300 of the spatial filter may include a transmitting antenna 310, an embedded filter 320 connected to the transmitting antenna 310 through a via, and a receiving antenna 330 connected to the embedded filter 320 through a via. The transmitting antenna 310 and the receiving antenna 330 may be electrically connected (or coupled), and the embedded filter 320 may be implemented in a transmission line between the transmitting antenna 310 and the receiving antenna 330.

The antenna-filter-antenna-based spatial filter may play the role of a repeater, and the receiving antenna 330 may receive (or obtain) an electromagnetic wave propagating in free space, and the received (or obtained) electromagnetic wave may pass through the embedded filter 320 and may be re-radiated by the transmitting antenna 310.

The antenna-filter-antenna-based spatial filter also has a feature of implementing the serial LC component of the filter, so it may have higher design freedom than the resonator-based spatial filter in implementing high-selectivity characteristics. The antenna-filter-antenna structure is normally designed as an asymmetrical unit cell structure, so the designed spatial filter may operate only for a specific polarized wave.

In order for the spatial filter to operate in the same way for all polarized waves, the unit cells must have a symmetrical shape with respect to both directions of the grid axes in which they are periodically arranged, and the filter structures for the two polarization components need to be provided inside each unit cell. However, this structure has difficulty in suppressing interference between the two polarization components, increases the design complexity of the filter structure connecting the transmitting and receiving antennas of the spatial filter, and has difficulty in miniaturizing the unit cell structure to a size less than half a wavelength.

The disclosure proposes a unit cell structure for resolving the complexity of filter structure design, based on a spatial filter in an antenna-filter-antenna structure.

The disclosure proposes a design method for a high-selectivity spatial filter incorporated with a filtering antenna (filtenna) having a filtering component in the antenna itself, instead of connecting (or coupling) a filter (e.g., the embedded filter 320) to a transmission line between two antennas (e.g., the transmitting antenna 310 and the receiving antenna 330).

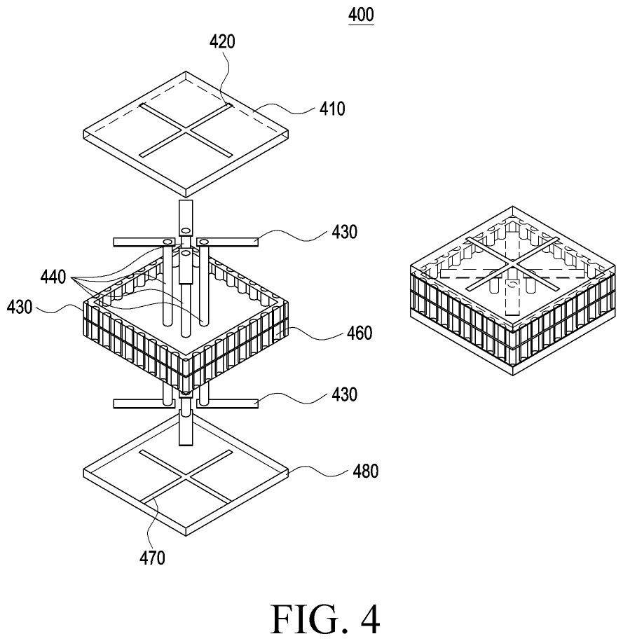

FIG. 4 illustrates a unit cell for a spatial filter implementing filtering performance according to an embodiment of the disclosure.

The unit cell 400 for the spatial filter may be implemented as a spatial filter unit cell shape based on a filter-filtenna structure that implements high-selectivity filtering performance without an antenna being embedded in the unit cell transmission line area.

Referring to FIG. 4, a unit cell 400 for a spatial filter may include a first substrate 410, a first cross-shaped metal 420 of a pattern M1, a dipole antenna 430 of patterns M2 and M4, a plurality of vias 440 of patterns M2 to M4, a ground (GND)/opening surface 450 of a pattern M3, a via wall 460 of patterns M2 to M4, a second cross-shaped metal 470 of a pattern M5, and a second substrate 480.

The first substrate 410 may be coupled to the first cross-shaped metal 420, and the first cross-shaped metal 420 may be connected to the dipole antenna 430. The via wall 460 may surround the plurality of vias 440, and the plurality of vias 440 may be electrically connected to the dipole antenna 430. The second substrate 480 may be coupled to the second cross-shaped metal 470, and the second cross-shaped metal 470 may be connected to the dipole antenna 430.

Although FIG. 4 illustrates, for convenience of explanation, an embodiment in which a parasitic element stacked on the dipole antenna 430 is the first cross-shaped metal 420, the number and shapes of the parasitic elements stacked on the dipole antenna 430 may be configured in various ways.

In addition, although FIG. 4 illustrates, for convenience of explanation, an embodiment in which a parasitic element stacked under the dipole antenna 430 is the second cross-shaped metal 470, the number and shapes of the parasitic elements stacked under the dipole antenna 430 may be configured in various ways.

The dipole antenna 430 of patterns M2 and M4 is a transmitting/receiving antenna of a spatial filter, and short-circuit pins may be connected to the ends of cross-shaped segmented bars. Therefore, a current is formed in the longitudinal direction of the bar, and the electromagnetic wave propagating in free space may be induced to the short-circuit pins. In this case, the length of the dipole antenna 430 is determined to be half of the wavelength in waveguide, based on the frequency at which the spatial filter is to transmit the signal.

For example, the wavelength in waveguide may be determined based on the following Equation 1.

$${λ}_{g} = \frac{c}{f √ {ε}_{r}} \qquad Equation 1$$

Here, λ_{g} is the wavelength in waveguide, c is the speed of light, f is the transmission frequency, and εᵣ is the relative dielectric constant of the lower dielectric substrate of the dipole antenna 430.

Each of the first cross-shaped metal 420 of a pattern M1 and the second cross-shaped metal 470 of a pattern M5 may be coupled to the dipole antenna 430. Each of the first cross-shaped metal 420 and the second cross-shaped metal 470 may be a parasitic element having the shape of a cross-shaped metal.

Since the first cross-shaped metal 420 and the second cross-shaped metal 470 are coupled to the dipole antenna 430, the frequency cutoff characteristics of the spatial filter may be improved.

The length of the parasitic element to cut off a specific frequency may be determined to be half of the wavelength in waveguide, and the wavelength in waveguide may be determined based on the following Equation 2.

$${λ}_{g} = \frac{c}{f √ {ε}_{eff}} \qquad Equation 2$$

Here, λg is the wavelength in waveguide, c is the speed of light, and f is the cutoff frequency. ε_{eff} is the effective relative dielectric constant of the substrate under the cross-shaped metal, and may be determined as the arithmetic mean of the relative dielectric constant of the dielectric substrate and the relative dielectric constant of free space ((εᵣ+1)/2).

The transmission and cutoff frequency of the dipole antenna and the parasitic element are determined according to the length and the dielectric constant of the dielectric substrate, and the user may determine the frequency characteristics of the spatial filter as desired by changing the length and the type of the dielectric substrate.

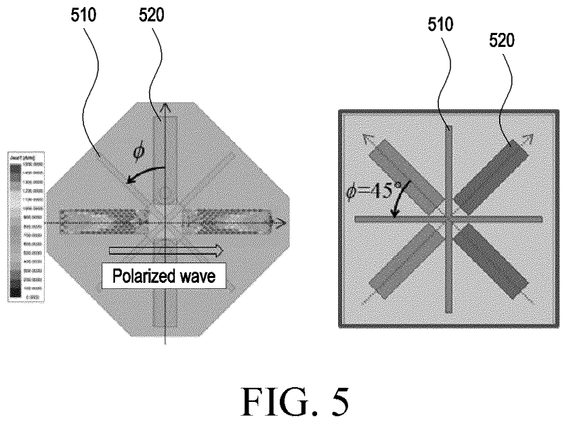

FIG. 5 illustrates an example of a dipole antenna and a non-aligned parasitic element according to an embodiment of the disclosure.

Referring to FIG. 5, when a parasitic element 510 (e.g., the first cross-shaped metal 420 and the second cross-shaped metal 470 in FIG. 4) is coupled with a dipole antenna 520 (e.g., the dipole antenna 430), the longitudinal axis of the parasitic element 510 and the longitudinal axis of the dipole antenna 520 may be coupled at an angle (e.g., φ=45°) of a non-aligned state.

If the parasitic element 510 and the dipole antenna 520 are aligned (e.g., φ=0°), the parasitic element 510 may hinder the current being supplied to the dipole antenna 520, and the transmission characteristics of the spatial filter may be damaged at the resonance frequency of the dipole antenna 520.

If the parasitic element 510 and the dipole antenna 520 are non-aligned, the effect of hindering the current supply to the dipole antenna 520 may be minimized in a transmission band. According to an embodiment, the range of the non-alignment angle φ, in which the transmission characteristics at the resonance frequency of the dipole antenna 520 is ensured and in which the cutoff characteristics at the resonance frequency of the parasitic element 510 is identified without interference with each other, may be 25° to 65°, and the height interval may be 0.1 mm to 1 mm.

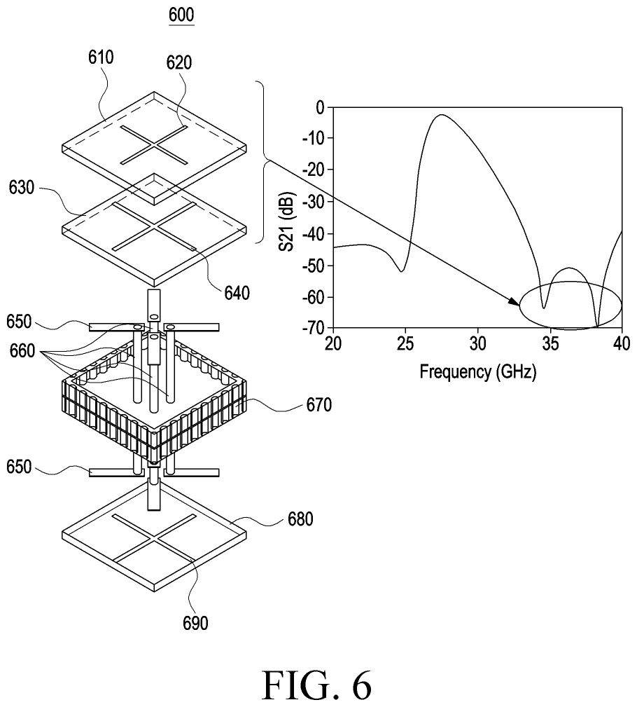

FIG. 6 is a diagram illustrating frequency cut-off characteristics in a case where parasitic elements are stacked in a spatial filter implementing filtering performance according to an embodiment of the disclosure.

A unit cell 600 for a spatial filter may be implemented as a spatial filter unit cell shape based on a filtenna-filtenna structure that implements high-selectivity filtering performance.

Referring to FIG. 6, the unit cell 600 for a spatial filter may include a first substrate 610, a first cross-shaped metal 620 disposed on the first substrate 610, a second substrate 630 stacked under the first substrate 610, a second cross-shaped metal 640 disposed on the second substrate 630, a dipole antenna 650, a plurality of vias 660 connected to the dipole antenna 650, and a via wall 670 surrounding the plurality of vias 660. According to an embodiment, the unit cell 600 for a spatial filter may further include a third substrate 680 disposed under the unit cell 600, and a third cross-shaped metal 690 disposed on the third substrate 680 and connected to the dipole antenna 650.

Although FIG. 6 illustrates, for convenience of explanation, an embodiment in which two parasitic elements (the first cross-shaped metal 620 and the second cross-shaped metal 640) are stacked on the dipole antenna 650, two or more parasitic elements may be stacked on the dipole antenna 650 depending on the design specifications.

In addition, although FIG. 6 illustrates, for convenience of explanation, an embodiment in which the shape of the parasitic element stacked on the dipole antenna 650 is a cross-shaped metal shape, the shape of the parasitic element stacked on the dipole antenna 650 may be configured in various shapes depending on the design specifications.

The unit cell 600 for the spatial filter shows an embodiment in which the first cross-shaped metal 620 and the second cross-shaped metal 640 connected to the dipole antenna 650 are stacked to enhance the frequency cutoff characteristics of the spatial filter. According to an embodiment, the number of cutoff frequencies increases according to the number of parasitic elements (e.g., cross-shaped metals) stacked inside the unit cell 600 for the spatial filter, and frequency signals in various bands may be cut off by adjusting the lengths of respective parasitic elements.

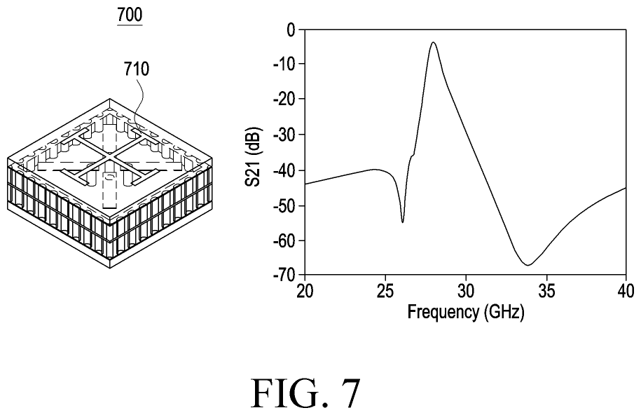

FIG. 7 is a diagram illustrating a case in which the same effect as a cross-shaped parasitic element is obtained from a spatial filter implementing filtering performance according to an embodiment of the disclosure.

Referring to FIG. 7, the shape of a parasitic element 710 in a unit cell 700 for a spatial filter may be changed from a simple cross shape to a modified cross shape (or cross potent shape) ( [symbol] ).

If the parasitic element 710 has a modified cross-shaped ( [symbol] ) structure, the physical size of the parasitic element 710 may be reduced for the same cutoff frequency, and thus the cutoff frequency band may be easily moved to a low frequency. According to an embodiment, the parasitic element 710 may be implemented through various modifications, such as bending or widening the end of the simple cross shape.

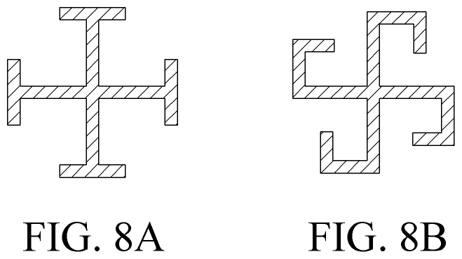

FIGS. 8A and 8B illustrate various cross-based parasitic elements according to various embodiments of the disclosure.

Referring to FIGS. 8A and 8B, a first parasitic element illustrated in FIG. 8A may be implemented in a first modified cross shape ( [symbol] ) and a second parasitic element illustrated in FIG. 8B may be implemented in a second modified cross shape). ( [symbol] ). The first parasitic element and the second parasitic element may have a common feature in which two bars cross vertically at the center of the structure.

The simple cross-shaped parasitic element has a limitation in which its length must be smaller than the size of the unit cell, and there may be a lower limit of the cutoff frequency due to the simple cross-shaped parasitic. The modified cross-shaped parasitic element according to the embodiments of the disclosure may further lower the lower limit of the cutoff frequency of the parasitic element through changes of the structure, thereby improving the frequency cutoff characteristics in a lower frequency band, as well as in a higher frequency band than the transmission band of the spatial filter to be designed.

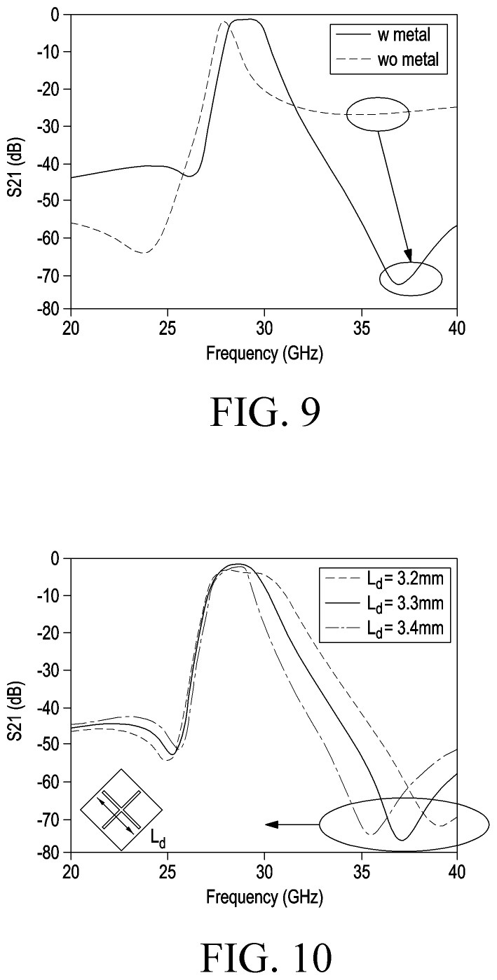

FIG. 9 is a diagram illustrating spatial filter transmission characteristics depending on the presence or absence of parasitic elements according to an embodiment of the disclosure.

FIG. 9 illustrates the transmission characteristics of a spatial filter in the case (“wo metal”) where only a dipole antenna exists in the spatial filter without a parasitic element (or metal) and in the case (“w metal”) where a dipole antenna and a parasitic element are combined in a spatial filter.

In the case where a dipole antenna and a parasitic element are combined in a spatial filter (“w metal”), the spatial filter may improve the cutoff characteristics at high frequencies without loss of transmission band. In addition, in the case where only a dipole antenna exists in a spatial filter without a parasitic element (or metal) (“wo metal”), the high frequency cutoff characteristics are relatively weakened, but it may play the role of a narrowband spatial filter.

FIG. 10 is a diagram illustrating cutoff frequency separation depending on parasitic element lengths according to an embodiment of the disclosure.

FIG. 10 illustrates the cutoff frequency separation depending on the length L_{d} of the parasitic element. FIG. 10 shows the cases where the length L_{d} of the parasitic element is 3.2 mm, where the length L_{d} of the parasitic element is 3.3 mm, and where the length L_{d} of the parasitic element is 3.4 mm.

Since the length L_{d} of the parasitic element and the wavelength in waveguide of the cutoff frequency are proportional, as the length L_{d} of the parasitic element becomes shorter, the cutoff frequency may increase, and as the length L_{d} of the parasitic element becomes longer, the cutoff frequency may decrease. For example, when the length L_{d} of the parasitic element is 3.2 mm, the cutoff frequency may increase, compared to when the length L_{d} of the parasitic element is 3.3 mm.

According to an embodiment, the frequency band that the user wishes to cut off may be adjusted by adjusting the length L_{d} of the parasitic element, thereby improving the quality of wireless communication.

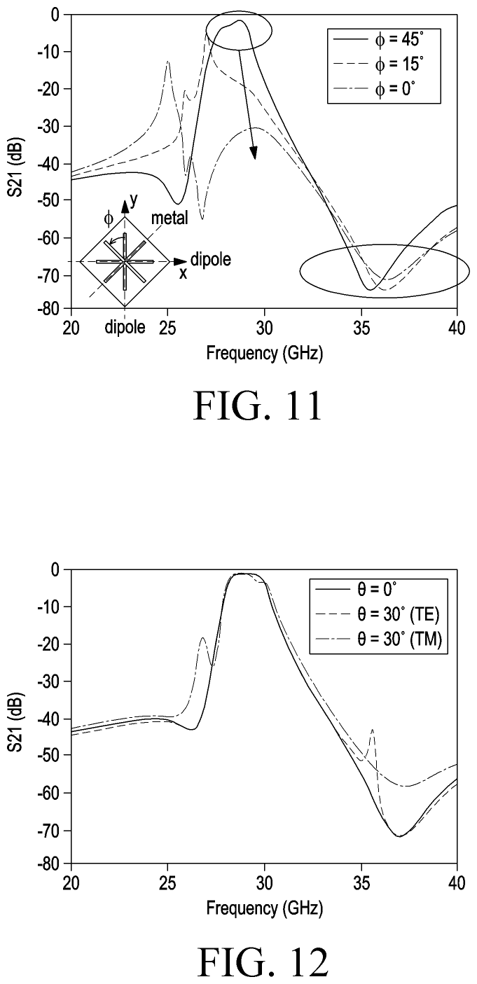

FIG. 11 is a diagram illustrating transmission characteristics depending on parasitic element alignment angles according to an embodiment of the disclosure.

FIG. 11 illustrates the transmission characteristics of a spatial filter according to the alignment angle ø of a parasitic element. The alignment angle ø of the parasitic element may indicate the angle difference between the positions where the parasitic element (metal) and the dipole antenna (dipole) are disposed, respectively. FIG. 11 shows the transmission characteristics in the cases where the alignment angle ø of the parasitic element is 45 degrees, where the alignment angle ø of the parasitic element is 15 degrees, and where the alignment angle ø of the parasitic element is 0 degrees, respectively.

The cutoff frequency of the spatial filter may be determined only by the length of the parasitic element, regardless of the alignment angle ø of the parasitic element. However, interference may occur in the transmission band characteristics of the spatial filter depending on a change in the alignment angle ø of the parasitic element. According to an embodiment, if the alignment angle ø of the parasitic element is within a range of a specific alignment angle, the spatial filter may function as a high-selectivity spatial filter.

FIG. 12 is a diagram illustrating transmission characteristics depending on each polarized wave according to an embodiment of the disclosure.

FIG. 12 illustrates the normal incidence transmission characteristics and the transmission characteristics of the spatial filter for an incidence angle of each polarized wave. FIG. 12 shows the transmission characteristics of the spatial filter in the cases where the incidence angle θ of the polarized wave is 0 degrees, where the incidence angle θ of the polarized wave is 30 degrees and the incidence transmission characteristics are transverse electric (TE), and where the incidence angle θ of the polarized wave is 30 degrees and the incidence transmission characteristics are transverse magnetic (TM), respectively.

Through the non-aligned coupling of the dipole antenna and the parasitic element, the spatial filter may form a filter response with high-selectivity characteristics even without a filter provided in the transmission line. According to an embodiment, the spatial filter according to an embodiment of the disclosure may be easily designed as a symmetrical structure, compared to a spatial filter based on an antenna-filter-antenna structure, and thus may be implemented as a spatial filter that operates in all polarized waves.

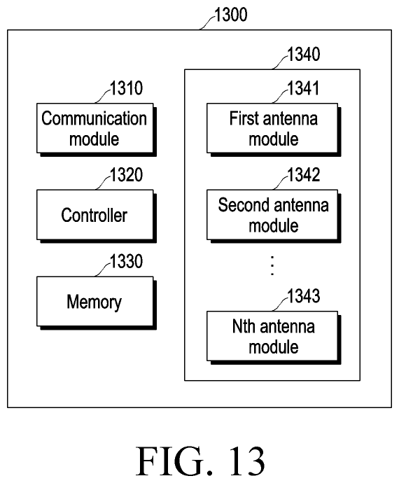

FIG. 13 is a diagram illustrating an electronic device including an antenna module according to an embodiment of the disclosure.

Referring to FIG. 13, an electronic device 1300 may include a communication module 1310, a controller 1320, memory 1330, and an antenna module set 1340. The antenna module set 1340 may include a first antenna module 1341, a second antenna module 1342, and an nₜₕ antenna module (wherein, n is a natural number greater than or equal to 3) 1343. Although FIG. 13 illustrates, for convenience of explanation, the antenna module set 1340 including n antenna modules, the technical idea of the disclosure is not limited thereto, and the antenna module set 1340 of the disclosure may include one or more antenna modules.

The communication module 1310 may support establishment of a direct (e.g., wired) communication channel or a wireless communication channel between the electronic device 1300 and an external electronic device, and communication through the established communication channel. The communication module 1310 may operate independently of the controller 1320 and may include one or more communication processors that support direct (e.g., wired) communication or wireless communication. According to an embodiment, the communication module 1310 may include a wireless communication module (e.g., a cellular communication module, a short-range wireless communication module, or a global navigation satellite system (GNSS) communication module) or a wired communication module (e.g., a local area network (LAN) communication module or a power line communication module). These various types of communication modules may be integrated into a single component (e.g., a single chip) or implemented as multiple separate components (e.g., multiple chips).

The controller 1320 may, for example, execute software to control at least one other component (e.g., a hardware or software component) of the electronic device 1300 connected to the controller 1320 and perform various data processing or calculations. According to an embodiment, as at least a part of the data processing or calculations, the controller 1320 may store commands or data received from other components (e.g., the communication module 1310 or the antenna module set 1340) in the memory 1330, process the commands or data stored in the memory 1330, and store the resultant data in the memory 1330. According to an embodiment, the controller 1320 may include a main processor (e.g., a central processing unit or an application processor) or an auxiliary processor (e.g., a graphics processing unit, a neural processing unit (NPU), an image signal processor, a sensor hub processor, or a communications processor) capable of operating independently or together with the main processor. For example, if the electronic device 1300 includes a main processor and an auxiliary processor, the auxiliary processor may be configured to use less power than the main processor or to be specialized for a specified function. The auxiliary processor may be implemented separately from the main processor or as a part thereof.

The memory 1330 may store various type of data used by at least one component (e.g., the communication module 1310, the controller 1320, or the antenna module set 1340) of the electronic device 1300. The data may include, for example, input data or output data for software and commands related thereto. The memory 1330 may include volatile memory or nonvolatile memory.

The antenna module set 1340 may transmit or receive signals or power to or from the outside (e.g., an external electronic device). According to an embodiment, the antenna module set 1340 may include at least one antenna including a radiator formed of a conductor or a conductive pattern formed on a substrate (e.g., a printed circuit board (PCB)). According to an embodiment, each of the first antenna module 1341 to the nₜₕ antenna module 1343 may include a unit cell for a spatial filter implementing filtering performance. The unit cell for the spatial filter may be implemented in a spatial filter unit cell shape based on a filtenna-filtenna structure that implements high-selectivity filtering performance without an antenna being provided in a unit cell transmission line area. The unit cell for the spatial filter may be configured as a combination of the dipole antenna and the parasitic element described above in FIGS. 4 to 7, 8A, and 8B.

According to an embodiment, each of the first antenna module 1341 to the nth antenna module 1343 may include a spatial filter device in which a pair of antennas transmitting and receiving radio waves in free space and a parasitic element performing a filtering function are coupled not to be aligned. According to an embodiment, the transmitting/receiving antenna pair may be configured as a cross-shaped metal with two longitudinal axes perpendicular to each other, and the antenna pair may be vertically connected with short-circuit pins. According to an embodiment, the antenna length may be configured as half of the wavelength in waveguide of the operating frequency.

According to an embodiment, the parasitic element may be configured as a shape in which two longitudinal axes are connected perpendicularly to each other at the center. In an embodiment, the length of the parasitic element may be configured as half of the wavelength in waveguide of the cutoff frequency.

According to an embodiment, the parasitic element may be coupled to the top of the antenna, and the gap between the parasitic element and the antenna may be implemented as 0.1 mm to 1 mm.

According to an embodiment, the alignment angle between the antenna pair and the parasitic element may be in the range of 25° to 65°. According to an embodiment, the alignment angle between the antenna pair and the parasitic element may be independently configured as 25° to 65° at the top and bottom, but may be configured at an optimal value of 45°.

According to an embodiment, the parasitic element may be configured as one or more elements. According to an embodiment, all of one or more parasitic elements may be coupled to the antenna pair while not being aligned. According to an embodiment, each of one or more parasitic elements has a frequency cutoff characteristic, and the cutoff frequency may be determined by the length of each parasitic element.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A spatial filter device comprising:
a first substrate having a first parasitic element configured to provide a filtering function and disposed on the spatial filter device;
a second substrate having a second parasitic element configured to provide a filtering function and disposed under the spatial filter device; and
a dipole antenna configured to transmit and receive radio waves in free space, coupled to each of the first parasitic element and the second parasitic element so as not to be aligned therewith, and disposed between the first substrate and the second substrate.

2. The device according to claim 1,
wherein the first parasitic element is configured as a cross-shaped metal or a modified cross-shaped metal, and
wherein the second parasitic element is configured as the cross-shaped metal or the modified cross-shaped metal.

3. The device according to claim 1, further comprising:
a third substrate having a third parasitic element configured to provide a filtering function and disposed on the first substrate,
wherein the third parasitic element is coupled to the dipole antenna so as not to be aligned therewith.

4. The device according to claim 1,
wherein two axes of the dipole antenna are configured as cross-shaped metals that are perpendicular to each other, and
wherein the dipole antenna is vertically connected with a short-circuit pin.

5. The device according to claim 4, wherein a length of the dipole antenna is configured as half of a wavelength in waveguide of an operating frequency.

6. The device according to claim 1,
wherein two axes of each of the first parasitic element and the second parasitic element are connected perpendicularly to each other at a center, and
wherein a length of each of the first parasitic element and the second parasitic element is configured as half of a wavelength in waveguide of a cutoff frequency.

7. The device according to claim 1,
wherein an alignment angle between the dipole antenna and the first parasitic element is configured in a range of 25° to 65°, and
wherein an alignment angle between the dipole antenna and the second parasitic element is configured in a range of 25° to 65°.

8. The device according to claim 1,
wherein an alignment angle between the dipole antenna and the first parasitic element is configured as 45°, and
wherein an alignment angle between the dipole antenna and the second parasitic element is configured as 45°.

9. The device according to claim 1,
wherein a cutoff frequency of the first parasitic element is determined based on a length of the first parasitic element, and
wherein a cutoff frequency of the second parasitic element is determined based on a length of the second parasitic element.

10. The device according to claim 1, further comprising:
a plurality of vias connecting a first portion of the dipole antenna connected to the first parasitic element and a second portion of the dipole antenna connected to the second parasitic element; and
a via wall configured to surround the plurality of vias.

11. An electronic device comprising:
a spatial filter device; and
one or more processors communicatively coupled to the spatial filter device,
wherein the spatial filter device comprises:
a first substrate having a first parasitic element configured to provide a filtering function and disposed on the spatial filter device,
a second substrate having a second parasitic element configured to provide a filtering function and disposed under the spatial filter device, and
a dipole antenna configured to transmit and receive radio waves in free space, coupled to each of the first parasitic element and the second parasitic element so as not to be aligned therewith, and disposed between the first substrate and the second substrate.

12. The device according to claim 11,
wherein the first parasitic element is configured as a cross-shaped metal or a modified cross-shaped metal, and
wherein the second parasitic element is configured as the cross-shaped metal or the modified cross-shaped metal.

13. The device according to claim 11, further comprising:
a third substrate having a third parasitic element configured to provide a filtering function and disposed on the first substrate,
wherein the third parasitic element is coupled to the dipole antenna so as not to be aligned therewith.

14. The device according to claim 11,
wherein two axes of the dipole antenna are configured as cross-shaped metals that are perpendicular to each other, and
wherein the dipole antenna is vertically connected with a short-circuit pin.

15. The device according to claim 14, wherein a length of the dipole antenna is configured as half of a wavelength in waveguide of an operating frequency.

16. The device according to claim 11,
wherein two axes of each of the first parasitic element and the second parasitic element are connected perpendicularly to each other at a center, and
wherein a length of each of the first parasitic element and the second parasitic element is configured as half of a wavelength in waveguide of a cutoff frequency.

17. The device according to claim 11,
wherein an alignment angle between the dipole antenna and the first parasitic element is configured in a range of 25° to 65°, and
wherein an alignment angle between the dipole antenna and the second parasitic element is configured in a range of 25° to 65°.

18. The device according to claim 11,
wherein an alignment angle between the dipole antenna and the first parasitic element is configured as 45°, and
wherein an alignment angle between the dipole antenna and the second parasitic element is configured as 45°.

19. The device according to claim 11,
wherein a cutoff frequency of the first parasitic element is determined based on a length of the first parasitic element, and
wherein a cutoff frequency of the second parasitic element is determined based on a length of the second parasitic element.

20. The device according to claim 11, wherein the spatial filter device further comprises:
a plurality of vias connecting a first portion of the dipole antenna connected to the first parasitic element and a second portion of the dipole antenna connected to the second parasitic element; and
a via wall configured to surround the plurality of vias.
